(19) United States
(12) Patent Application Publication
(10) Pub. No.: US 2013/0103362 A1
(43) Pub. Date: Apr. 25, 2013

(54) SYSTEM AND METHOD FOR FIRE & GAS DETECTION

(71) Applicants: Bill MATHER, (US); Brian Harvey, (US); Karen Wigal, (US); Derek Nelson, (US)

(72) Inventors: Bill MATHER, (US); Brian Harvey, (US); Karen Wigal, (US); Derek Nelson, (US)

(21) Appl. No.: 13/614,323

(22) Filed: Sep. 13, 2012

Related U.S. Application Data
(60) Provisional application No. 61/573,143, filed on Sep. 13, 2011.

(51) Int. Cl. G06F 17/50

(52) U.S. Cl. CPC G06F 17/5004
USPC 703/1

(57) ABSTRACT

A fire and gas detector placement system and method comprises one or more computer processors; and a non-transitory computer readable medium. The non-transitory computer readable medium contains instructions that, when executed, cause the one or more processors to perform the steps of identifying a position of at least one fire and gas detector in a premises using a calculation based on a plurality of parameters; and generating a 3-dimensional representation of the premises including the position of the at least one fire and gas detector.

### CROSS REFERENCE TO PROVISIONAL APPLICATION AND RELATED APPLICATIONS

This application is based upon and claims the benefit of priority from Provisional U.S. Patent Application 61/573,143 filed on Sep. 13, 2011, the entire contents of which are incorporated by reference herein.

### BACKGROUND

1. Field of Disclosure

This disclosure relates to fire and gas detection. The present disclosure has particular applicability to systems and methods for identifying the proper placement of fire and gas detectors in areas by use of calculations based on certain parameters and generating visual representations based on the calculations.

2. Description of Related Art

The placement of fire and gas detection equipment is an important aspect of operating a materials processing facility. Currently, there are no regulatory requirements for the location of fire and gas detection equipment. The National Fire Protection Association (NFPA) and American Petroleum Institute (API) issue guidelines for the placement of detectors, such as API RP 500. However, the guidelines are subjective and do not cover all risks.

Conventional methods of meeting the above guidelines are based solely on industry experience. A typical methodology consists of categorizing a facility based on congestion and potential release sources. There categories dictate a minimum number of detectors for each area based on its category, but determining how to classify theses categories is subjective. Therefore, existing methodologies to fire and gas detector locating tends to be subjective and qualitative.

### SUMMARY

In order to overcome the problems discussed above, the present disclosure is directed to fire and gas detector placement system and method comprising one or more computer processors, and a non-transitory computer readable medium. The non-transitory computer readable medium contains instructions that, when executed, cause the one or more processors identify a position of at least one fire and gas detector in a premises using a calculation based on a plurality of parameters, and generating a 3-dimensional representation of the premises including the position of the at least one fire and gas detector.

The disclosure is also directed toward a fire and gas detector placement optimization system and method comprising one or more computer processors, and a non-transitory computer readable medium containing instructions that, when executed, cause the one or more processors to perform the steps of analyzing a preexisting map of a premises containing at least one fire and gas detector with one or more computer processors based on a plurality of parameters; identifying an optimum position of at least one fire and gas detector in a premises by use of the one or more computer processors based on the results of the analyzing step; and generating a 3-dimensional representation of the premises including the optimum position of the at least one fire and gas detector.

In some embodiments of the present disclosure, the parameters comprise a coverage area for the at least one fire and gas detector, and a 3-dimensional coordinate location of at least one selected from the group of vessels, equipment, buildings, structures and pipelines at the premises.

In some embodiments of the present disclosure, to determine the position of at least one fire and gas detector at the premises, the one or more computer processors utilizes a consequence and risk result contour for flammable materials at the premises. In other embodiments, the one or more computer processors utilizes a consequence and risk result contour for thermal gradients at the premises. In still other embodiments, the one or more computer processors utilizes a consequence and risk result contour for fatalities at the premises.

Additional advantages and other features of the present disclosure will be set forth in part in the description which follows and in part will become apparent to those having ordinary skill in the art upon examination of the following or may be learned from the practice of the disclosure. The advantages of the disclosure may be realized and obtained as particularly pointed out in the appended claims.

As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

FIGS. 1 and 2 are flow charts showing the process steps of placing and optimizing fire and gas detection coverage according to an embodiment of the present disclosure;

FIG. 3 is an a map of a premises to be used for fire and gas detection placement according to another embodiment of the present disclosure;

FIG. 4 is an example of a vessel data entry form according to another embodiment of the present disclosure;

FIG. 5 is an example of a structure data entry form according to another embodiment of the present disclosure;

FIG. 6 is an example of a building data entry form according to another embodiment of the present disclosure;

FIG. 7 is an example of a pipeline data entry form according to another embodiment of the present disclosure;

FIG. 8; is a top view of a 2-dimensional representation of a premises containing entered data according to another embodiment of the present disclosure;

FIG. 9 is a 3-dimensional representation of FIG. 8;

FIG. 10 a top view of a 2-dimensional representation of a premises showing the risk contours according to another embodiment of the present disclosure;

FIG. 11 a top view of a 2-dimensional representation of a premises showing the flammable contours according to another embodiment of the present disclosure;

FIG. 12 a top view of a 2-dimensional representation of a premises showing the thermal contours according to another embodiment of the present disclosure;

FIG. 13 a top view of a 2-dimensional representation of a premises showing locations of fire and gas detectors according to another embodiment of the present disclosure;

FIG. 14 is a top view of a representation showing coverage of fire and gas detectors of an area of a premises at 10 foot elevation according to another embodiment of the present disclosure;

FIG. 15 is a top view of a representation showing coverage of fire and gas detectors of the area of the premises of FIG. 14 at 30 foot elevation;

FIG. 16 3-dimensional representation of the fire and gas detection coverage of a premises;

FIG. 17 is a flow chart showing the process steps of placing and optimizing fire and gas detection coverage according to another embodiment of the present disclosure;

FIG. 18 is a simplified functional block diagram of a computer that may be configured as a host or server, for example, to function as the processor in a hazardous area classification system of one embodiment of the present disclosure; and

FIG. 19 is a simplified functional block diagram of a personal computer or other work station or terminal device.

### DETAILED DESCRIPTION

The drawing figures depict one or more implementations in accord with the present teachings, by way of example only, not by way of limitation. In the figures, like reference numerals refer to the same or similar elements.

The present disclosure is directed toward a system and method for identifying and optimizing the placement of fire and gas detectors in a premises. The methodology utilizes a 3-dimensional representation software to model a facility including equipment, structures, buildings and piping. Flammable gas boundaries, thermal radiation boundaries and flammable/thermal geographic risk contours combine to inform users of high hazard areas that would benefit from added fire and gas detectors.

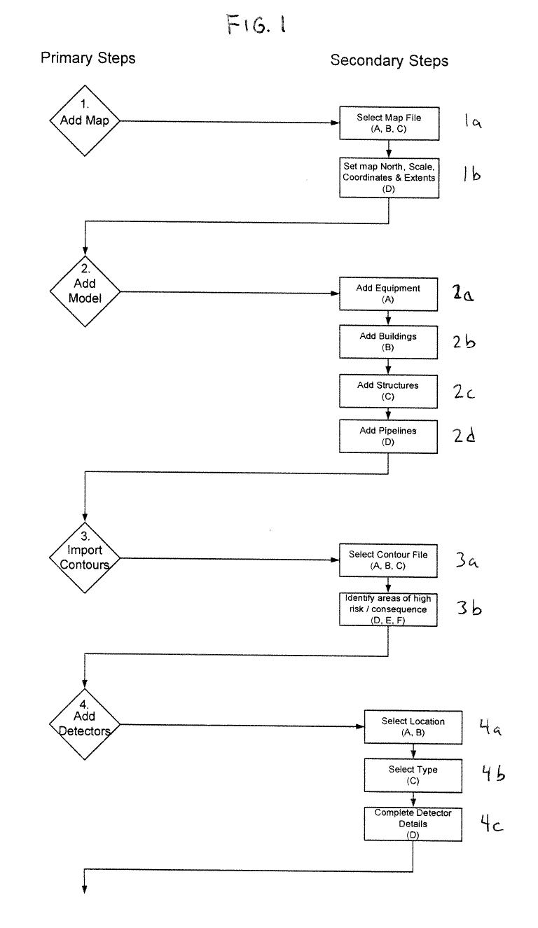

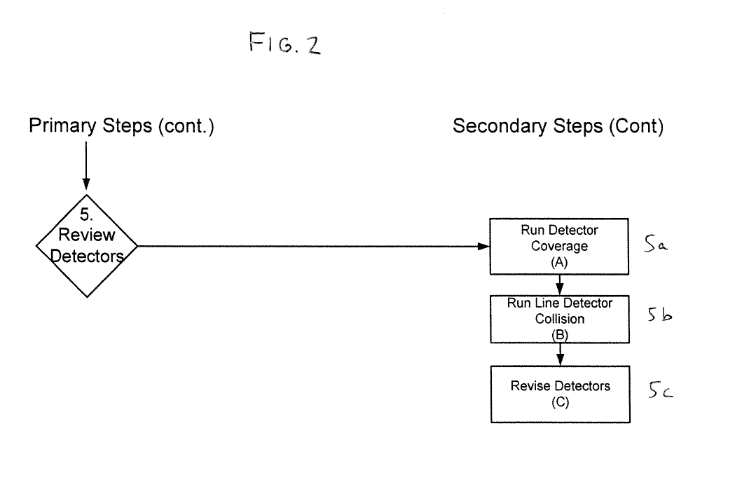

FIGS. 1 and 2 show general steps for a method of fire and gas detector placement. In FIGS. 1 and 2 steps may be eliminated or put in a different order as desired. Fire and gas detectors placement is determined by utilizing one or more processors and a non-transitory computer readable medium containing a set of instructions that, when executed, cause the one or more processors identify a position of at least one fire and gas detector in a premises using a calculation based on a plurality of parameters, and generating a 3-dimensional representation of the premises including the position of the at least one fire and gas detector.

In other embodiments, the instructions cause the one or more processors to perform the steps of analyzing a preexisting map of a premises containing at least one fire and gas detector with one or more computer processors based on a plurality of parameters; identifying an optimum position of at least one fire and gas detector in a premises by use of the one or more computer processors based on the results of the analyzing step; and generating a 3-dimensional representation of the premises including the optimum position of the at least one fire and gas detector.

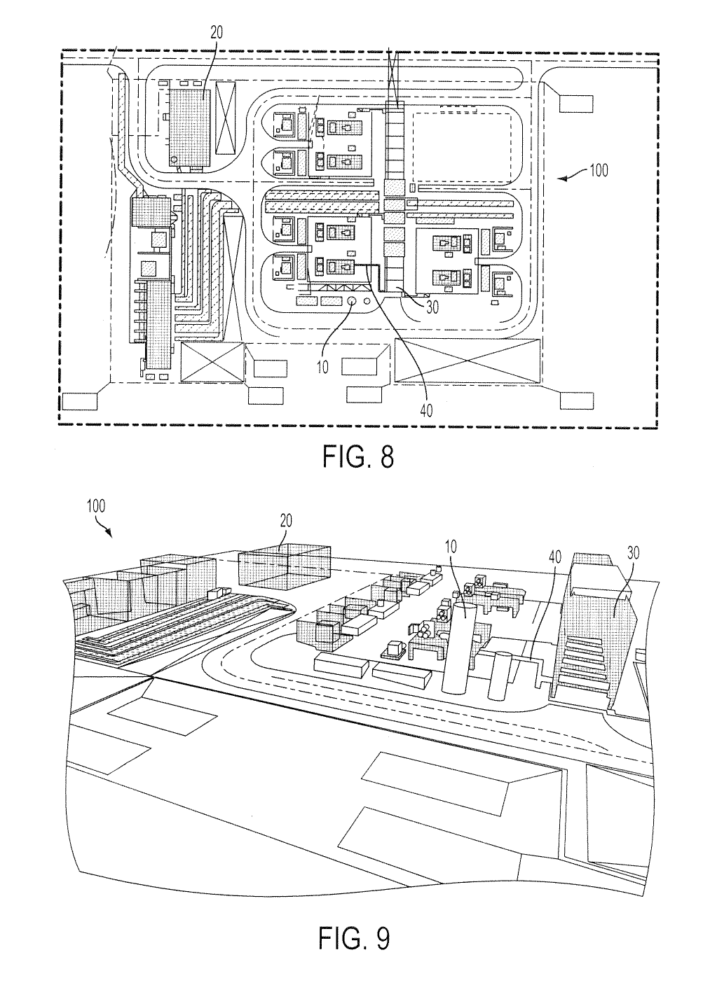

The parameters include, but are not limited to a coverage area for the at least one fire and gas detector; a 3-dimensional coordinate location of at least one selected from the group of equipment, such as vessels 10, buildings 20, structures 30 and pipelines 40 at the premises (see, for example, FIGS. 8-9), a consequence and risk result contour for flammable materials, thermal gradients, and/or risk of fatalities at the premises. Any other parameters that may contribute to the determination of a hazardous area may also be used.

The steps disclosed herein can be implemented using well-known conventional computer programs such as VisualBasic.NET™ (available from Microsoft Inc., Redmond, Wash.) and can use a conventional framework such as Microsoft.NET™ (available from Microsoft Inc., Redmond, Wash.) to define and draw the representations. One embodiment of the disclosed methodology is a computer program entitled “F&GTool” utilized to conduct steps for performing the hazardous area classification. In use, F & G Tool is opened and a new file is created for each location to be classified. The method comprises a step 1 of selecting a location for analysis, for example, a map. The map may be of various vector and raster formats suitable for computer graphical drawing. This map is selected in step 1a of FIG. 1. Examples of these formats include .DWG, .DGN, .JPG, .TIF, .BMP, or the like. Information for certain map parameters such as the direction of north, the size and extent of the map, map coordinates, and any other information necessary to draw a map is inputted by a user in step 1b.

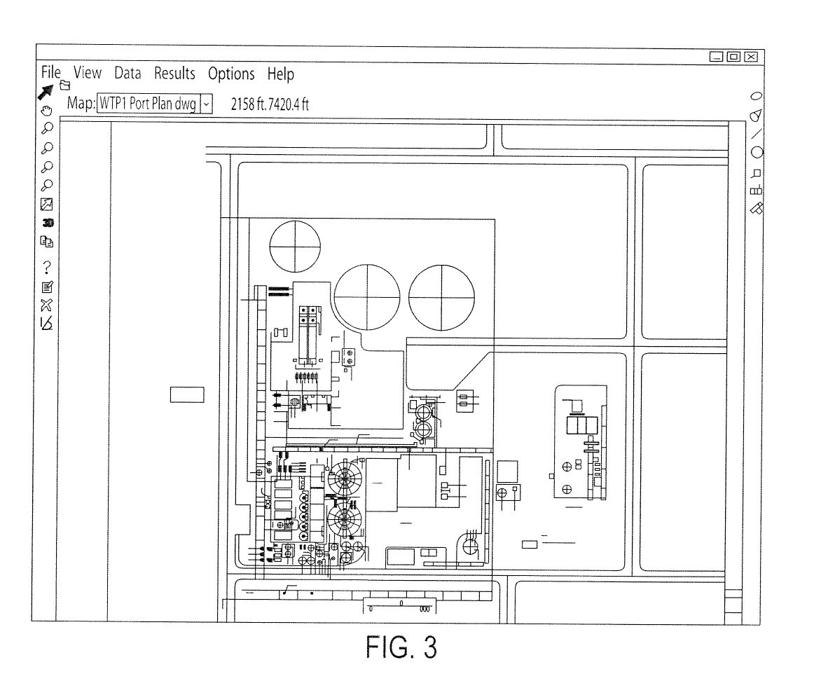

In other embodiments, a pre-existing map may be loaded on the F & G Tool for analysis. FIG. 3 shows the F & G Tool Map Interface with a loaded map.

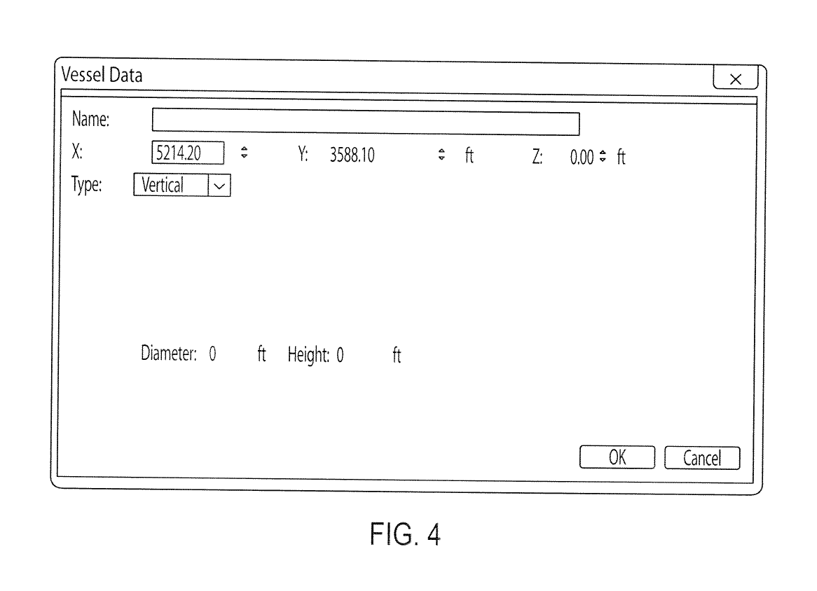

Turning back to FIGS. 1 and 2, in step 2, the model parameters including all elements of the map are added. In step 2a, equipment, such as vessels are added. To add vessels, a point on the map where the vessel is to be added is selected with a mouse and the vessel identified in a dialogue box. The vessels unique name, along with type, size and elevation are included in the information. FIG. 4 shows an example of vessel data added during step 2a.

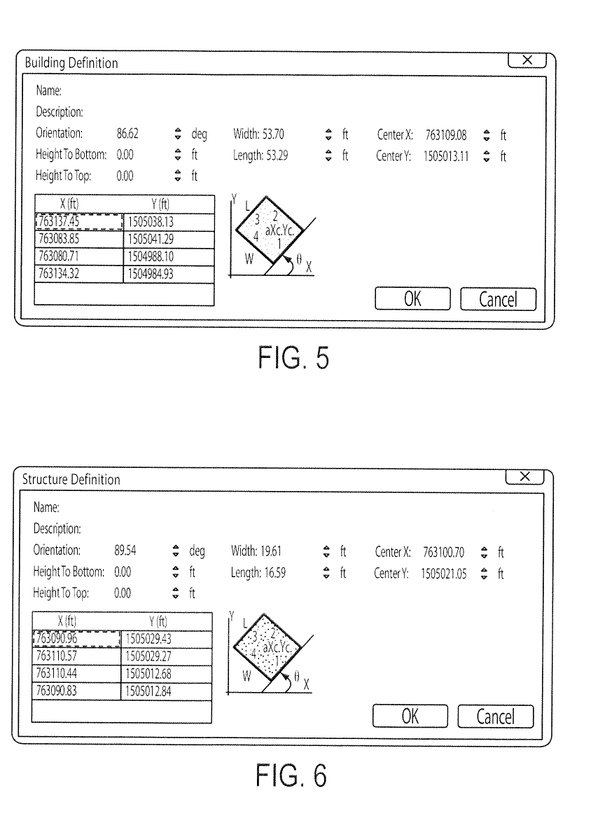

In step 2b, buildings are added. To add buildings, two points to define two neighbored vertices of the building are selected on the map where the building is to be added. A red rectangle will appear as the proposed outline of the building. A third point is selected with a mouse to define the third and fourth points of the building. In a dialog box, information about the building's unique name, along with angle, size and elevation are included. FIG. 5 shows an example of building data added during step 2b.

In step 2c, structures are added. To add structures, two points to define two neighbored vertices of the structure are selected on the map where the structure is to be added. A red rectangle will appear as the proposed outline of the structure. A third point is selected with a mouse to define the third and fourth points of the structure. In a dialog box, information about the structure's unique name, along with angle, size and elevation are included. FIG. 6 shows an example of structure data added during step 2c.

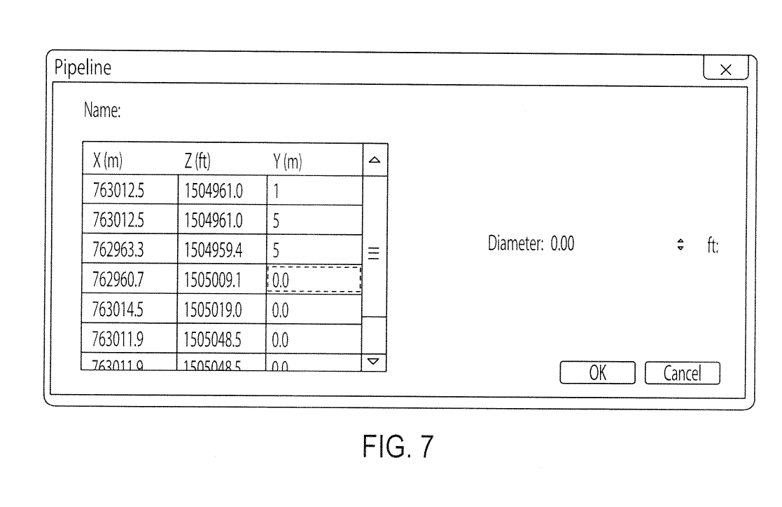

In step 2d, pipelines are added. To add pipelines, the points on the map where the pipeline path is located are selected. For vertical pipeline segments, the same location is selected twice. In a dialog box, information about the pipeline's unique name, along with diameter and elevation are included. FIG. 7 shows an example of Pipeline data added during step 2d.

Once the elements of the map are included, a representation of the facility is generated. FIG. 8 shows a 2-dimensional representation of a premises 100 indicating various elements such as equipment including vessels 10, buildings 20, structures 30 and pipelines 40. FIG. 9 is a 3-dimensional representation of FIG. 8.

Once the map is generated, a user can edit the information in the map if desired.

In step 3 shown in FIG. 1, contours representing flammability and thermal gradients are then imported. Flammable and thermal contours show where areas of vulnerability are for any given unit or site in a premises 100. The contours can be imported from other known software such as SafeSite™ or QRATool™ (available from BakerRisk, San Antonio, Tex.). However, gas detector models can be prepared without the interaction of consequence or risk models as well; thus SafeSite™ or QRATool™ is not required.

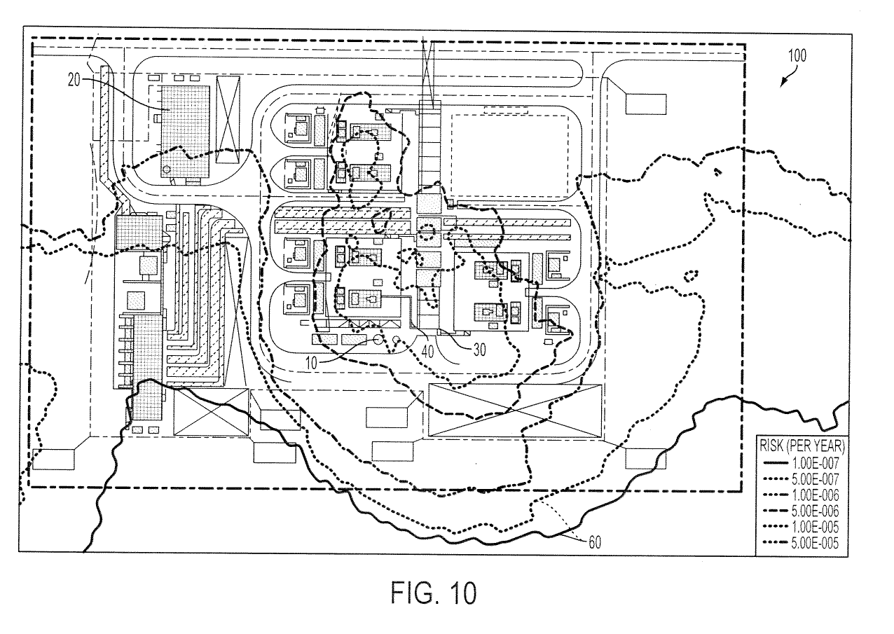

In this case, the contour type is selected from a menu of contours. Once the contours have been imported, they may be viewed. FIGS. 10-12 show contours for various parameters. For example, FIG. 10 shows an example of fatality risk contours 60. The fatality risk contours 60 are delineated into various levels of risk. In FIG. 10, the fatality risk contours 60 are divided into levels of 100,000, 500,000, 1,000,000, 5,000,000, 10,000,000 and 50,000,000 fatalities/year. Other levels of fatality risk can be used depending on the elements shown in the premises 100.

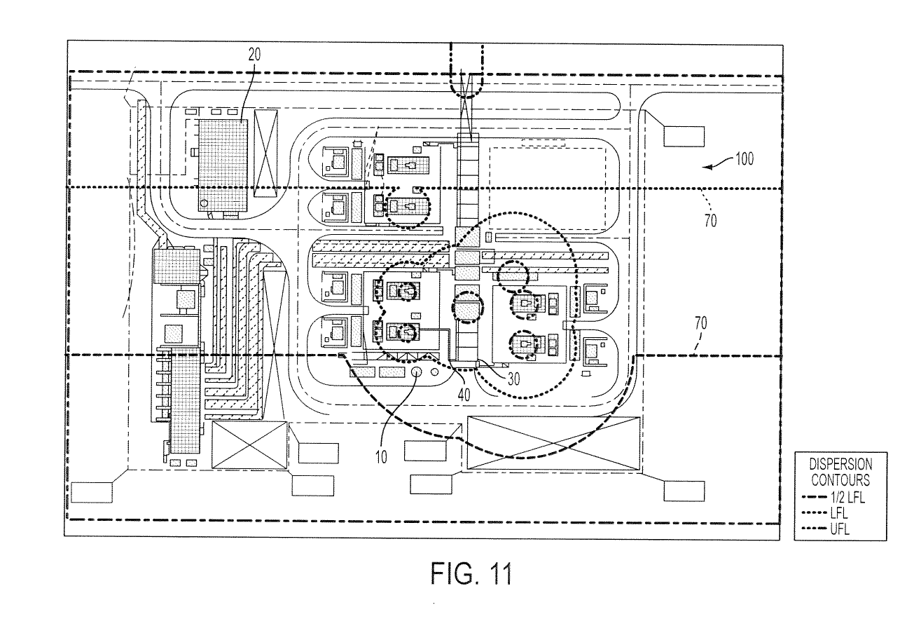

FIG. 11 shows an example of flammable material risk contours 70. The flammable risk contours 70 are delineated into various levels of risk. In FIG. 11, the flammable risk contours 70 are divided into levels of 1/2 LFL, LFL and UFL. Other levels of flammable risk can be used depending on the elements shown in the premises 100.

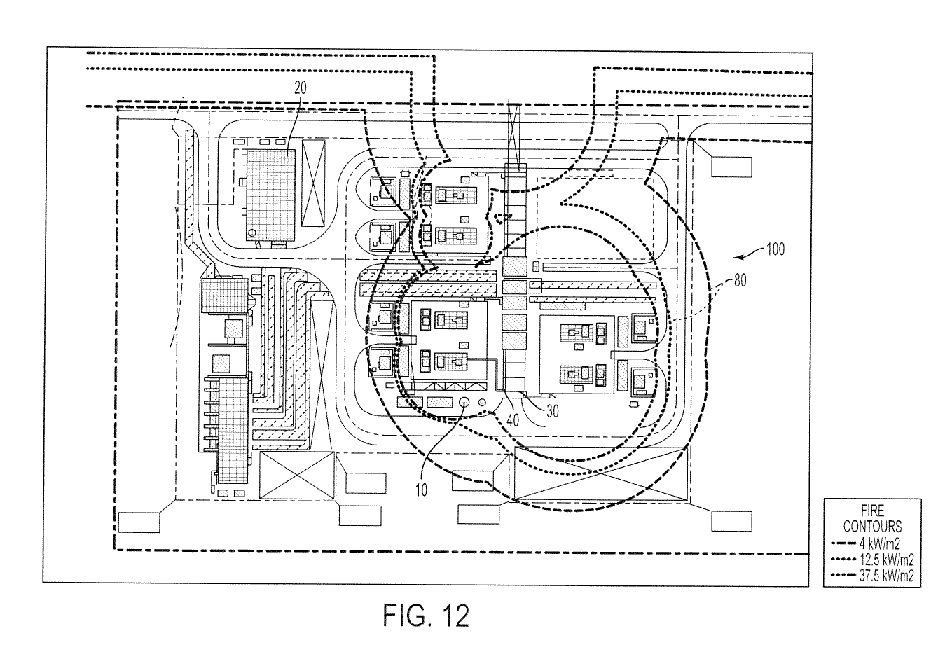

FIG. 12 shows an example of thermal risk contours 80. The thermal risk contours 80 are delineated into various levels of risk. For example, in FIG. 12, the thermal risk contours 80 are divided into levels of 4 kW/m², 12.5 kW/m² and 37.5 kW/m². Other levels of thermal risk can be used depending on the elements shown in the premises 100.

In step 4 of FIG. 1, the detectors are then added. Detectors are divided into two main categories: fire and gas; and have three main types: point, line and cone type detectors.

In step 4a, the location of the detector 50 and then placed on the map of the premises 100 via a mouse. The location is selected according to the amount of risk for each of the various parameters discussed above. Once the location of the detector 50 is selected, the type of detector 50 is selected from a menu in step 4b. Once added, the detector 50 is given a unique name, and can include the type, size, angle, orientation and elevation in step 4c.

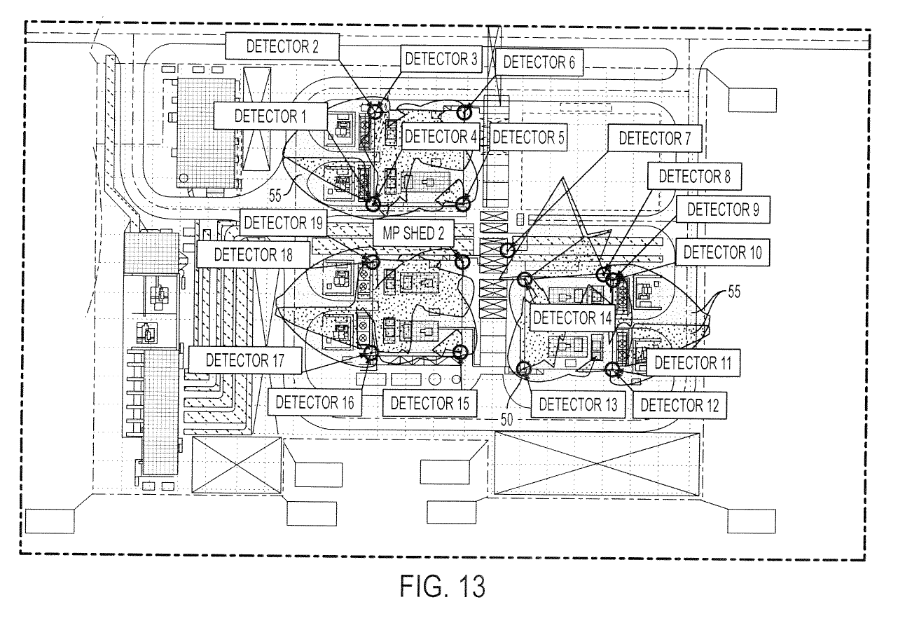

In step 5, the detectors 50 that have been placed in FIG. 4 are now reviewed to determine the coverage 55 of the detectors 50. The F & G Tool uses a combination of 3-dimensional (3D) graphics and geometry to show the area on the ground or any other height that is covered by the detectors 50 in step 5a. In addition, areas that are not covered by a detector because of, for example, blocking from obstacles such as equipment, buildings 20 or structures 30 are shown. The 3D graphics can show the area on the ground covered. For example, FIG. 13 shows various detectors 50 placed about a premises 100. The coverage areas 55 are shown as shaded portions.

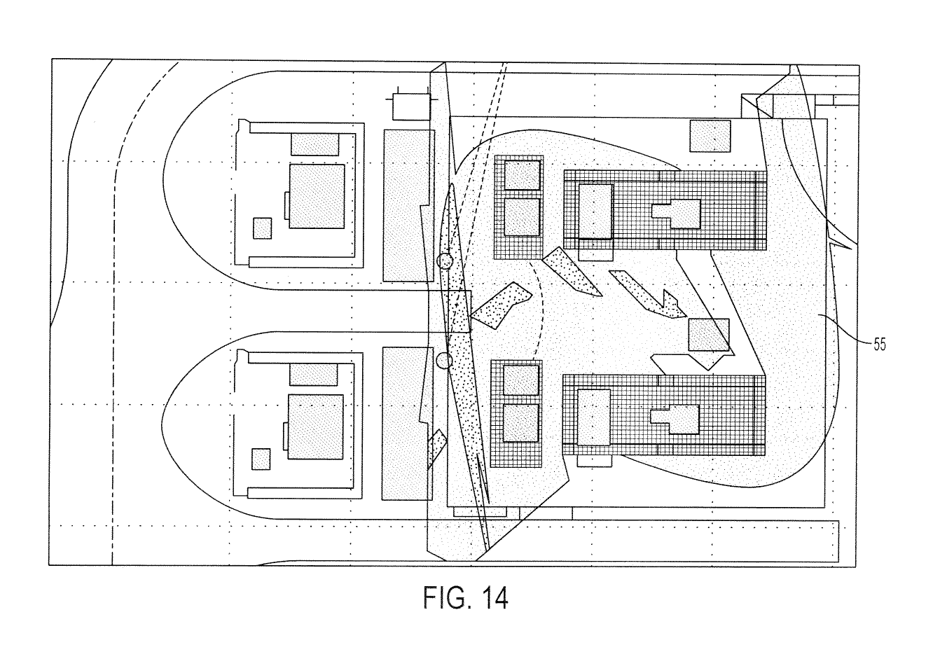

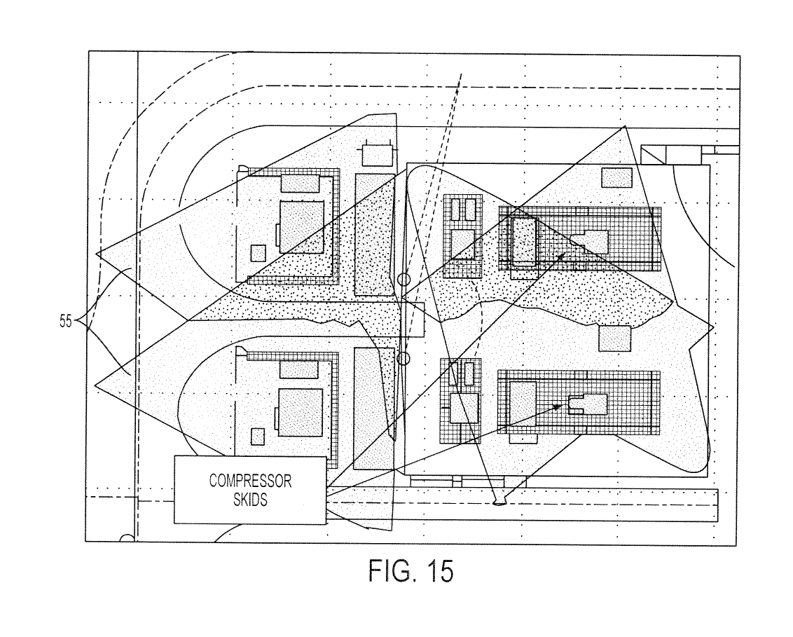

In step 5b, line detector collisions are developed. The F & G Tool is able to detect collisions between detectors 50 and objects, like equipment, buildings 20, structures 30 and the like. The detector coverage 55 will appear graphically on the map. Furthermore, the coverage 55 can be for any height. For example, FIG. 14 shows an example of detector coverage 55 at a height of 10 feet off the ground of an exemplary premises 100. FIG. 15 shows an example of detector coverage 55 at a height of 30 feet off the ground of the same premises 100 as FIG. 14. At each height, the detector 50 is adjusted to correct for any issues with blocked coverage 55 in step 5c.

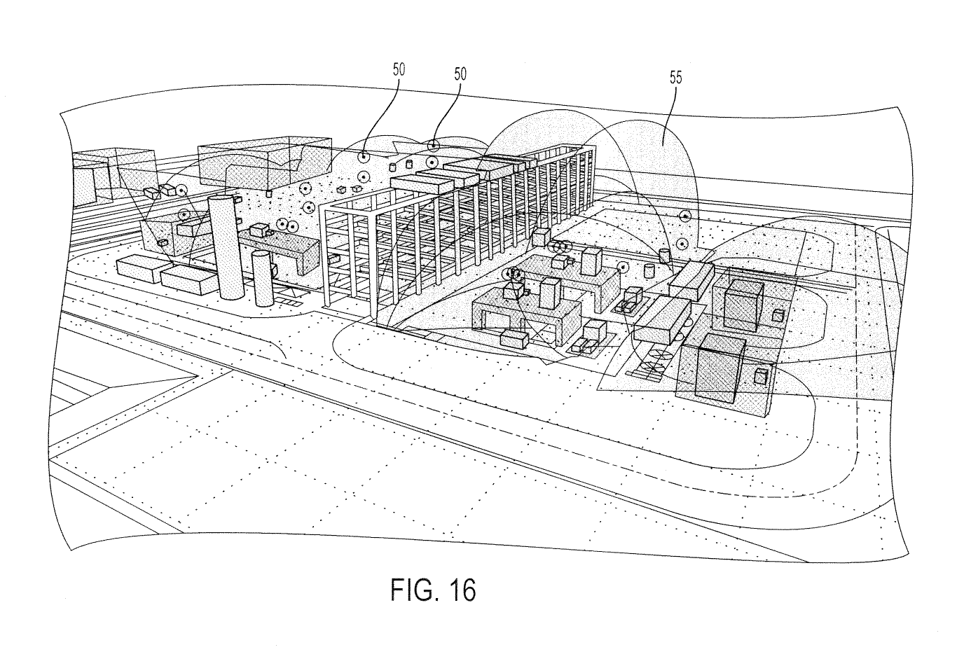

FIG. 16 shows an example of a 3D representation of the fire and gas detector coverage 55. As is shown, the coverage 55 provided allows a user to identify areas where high risk is involved, as well as areas in which blockages to detection resulting in gaps in coverage 55 may be, allowing the user to optimize the coverage 55 of the detectors to overcome the blockages.

In other embodiments, the F & G Tool is used to analyze a preexisting map of a premises 100 containing fire and gas detectors 50. The map is imported from a database, or otherwise drawn as discussed above, indicating the pre-existing placement of detectors 50. The F & G Tool is then used to identify the optimum position of the fire and gas detectors 50, thereby allowing a customer to increase safety at a premises 100 while decreasing the costs of unnecessary or underutilized detectors.

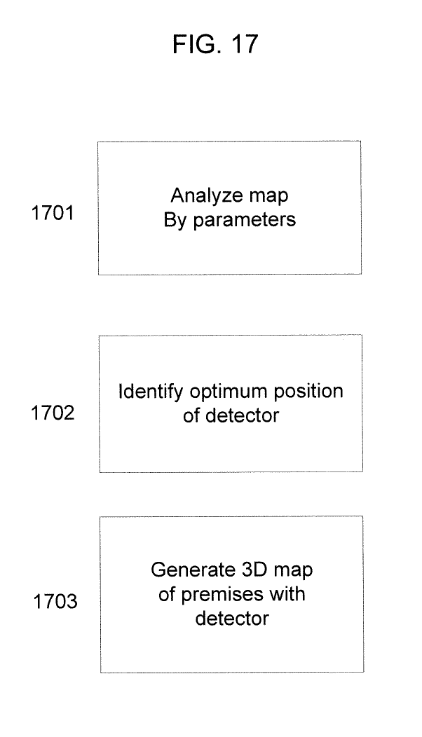

FIG. 17 is a flow chart showing the steps of a method for optimizing fire and gas detector placement. In step 1701, the map of a premises containing at least one fire and gas detector 50 is analyzed with one or more computer processors based on a plurality of parameters. The parameters are the same as those discussed above. Then, the optimum position of at least one fire and gas detector 50 is identified in step 1702 by use of the one or more computer processors based on the results of the analyzing step.

After identifying the optimum position of the detectors 50, a 3-dimensional representation of the premises indicating the optimum position of the at least one fire and gas detector 50 is generated in step 1703.

Other concepts relate to unique software for implementing the fire and gas detector placement system. A software product, in accord with this concept, includes at least one machine-readable medium and information carried by the medium. The information carried by the medium may be executable program code, one or more databases and/or information regarding hazardous area classification systems.

As shown by the above discussion, functions relating to the fire and gas detector placement system may be implemented on computers connected for data communication via the components of a packet data network. Although special purpose devices may be used, such devices also may be implemented using one or more hardware platforms intended to represent a general class of data processing device commonly used to run “server” programming so as to implement the classification functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives, etc.) for code and data storage, and one or more network interface cards or ports for communication purposes. The software functionalities involve programming, including executable code as well as associated stored data, e.g. files used for the hazardous area classification system. The software code is executable by the general-purpose computer that functions as the server and/or that functions as a terminal device. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for fire and gas detector placement in essentially the manner performed in the implementations discussed and illustrated herein.

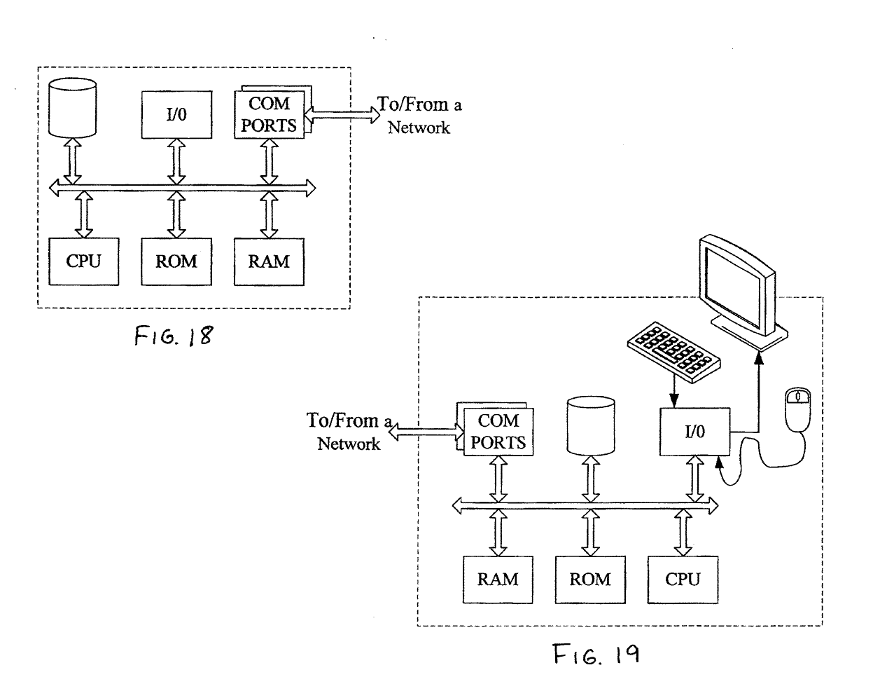

FIGS. 18 and 19 provide functional block diagram illustrations of general purpose computer hardware platforms. FIG. 18 illustrates a network or host computer platform, as may typically be used to implement a server. FIG. 19 depicts a computer with user interface elements, as may be used to implement a personal computer or other type of work station or terminal device, although the computer of FIG. 19 may also act as a server if appropriately programmed. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

Hence, aspects of the methods of fire and gas detector placement outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the service provider into the computer platform of the user that will be the server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the calculation steps, processing steps, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The present disclosure can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the disclosure. However, it should be recognized that the present disclosure can be practiced without resorting to the details specifically set forth. In other instances, well known processing structures have not been described in detail, in order not to unnecessarily obscure the present disclosure.

Only a few examples of the present disclosure are shown and described herein. It is to be understood that the disclosure is capable of use in various other combinations and environments and is capable of changes or modifications within the scope of the inventive concepts as expressed herein.

1. A fire and gas detector placement system comprising:
one or more computer processors; and
a non-transitory computer readable medium containing instructions that, when executed, cause the one or more processors to perform the steps of:
identifying a position of at least one fire and gas detector in a premises using a calculation based on a plurality of parameters; and
generating a 3-dimensional representation of the premises including the position of the at least one fire and gas detector.

2. The fire and gas detector placement system of claim 1, wherein the parameters comprise:
a coverage area for the at least one fire and gas detector; and
a 3-dimensional coordinate location of at least one selected from the group of vessels, equipment, buildings, structures and pipelines at the premises.

3. The fire and gas detector placement system of claim 1, wherein the one or more computer processors is configured to determine the position of at least one fire and gas detector in a premises based on a consequence and risk result contour for flammable materials at the premises.

4. The fire and gas detector placement system of claim 1, wherein the one or more computer processors is configured to determine the position of at least one fire and gas detector in a premises based on a consequence and risk result contour for thermal gradients at the premises.

5. The fire and gas detector placement system of claim 1, wherein the one or more computer processors is configured to determine the position of at least one fire and gas detector in a premises based on a consequence and risk result contour for fatalities at the premises.

6. The fire and gas detector placement system of claim 1, wherein the at least one fire and gas detector is one from the group selected from a point gas detector, a line of sight gas detector, and a conical fire detector.

7. A method of placement of fire and gas detectors comprising the steps of:
inputting a plurality of parameters related to a premises;
identifying a position of at least one fire and gas detector at the premises using one or more computer processors; and
generating a 3-dimensional representation of the premises indicating the position of the at least one fire and gas detector.

8. The method of claim 7, wherein the parameters comprise:
a coverage area for the at least one fire and gas detector; and
a 3-dimensional coordinate location of at least one selected from the group of vessels, equipment, buildings, structures and pipelines at the premises.

9. The method of claim 7, wherein in the step of determining the position of at least one fire and gas detector at the premises, the one or more computer processors utilizes a consequence and risk result contour for flammable materials at the premises.

10. The method of claim 7, wherein in the step of determining the position of at least one fire and gas detector at the premises, the one or more computer processors utilizes a consequence and risk result contour for thermal gradients at the premises.

11. The method of claim 7, wherein in the step of determining the position of at least one fire and gas detector at the premises, the one or more computer processors utilizes a consequence and risk result contour for fatalities at the premises.

12. The method of claim 7, wherein the at least one fire and gas detector is one of the group selected from a point gas detector, a line of sight gas detector, and a conical fire detector.

13. A fire and gas detector placement optimization system comprising:
one or more computer processors; and
a non-transitory computer readable medium containing instructions that, when executed, cause the one or more processors to perform the steps of:
analyzing a preexisting map of a premises containing at least one fire and gas detector with one or more computer processors based on a plurality of parameters;
identifying an optimum position of at least one fire and gas detector in a premises by use of the one or more computer processors based on the results of the analyzing step; and
generating a 3-dimensional representation of the premises including the optimum position of the at least one fire and gas detector.

14. The fire and gas detector placement system of claim 13, wherein the parameters comprise:
a coverage area for the at least one fire and gas detector; and
a 3-dimensional coordinate location of at least one selected from the group of vessels, equipment, buildings, structures and pipelines at the premises.

15. The fire and gas detector placement system of claim 13, wherein the one or more computer processors is configured to determine the optimum position of at least one fire and gas detector in a premises based on a consequence and risk result contour for flammable materials at the premises.

16. The fire and gas detector placement system of claim 13, wherein the one or more computer processors is configured to determine the optimum position of at least one fire and gas detector in a premises based on a consequence and risk result contour for thermal gradients at the premises.

17. The fire and gas detector placement system of claim 13, wherein the one or more computer processors is configured to determine the optimum position of at least one fire and gas detector in a premises based on a consequence and risk result contour for fatalities at the premises.

18. The fire and gas detector placement system of claim 13, wherein the at least one fire and gas detector is one from the group selected from a point gas detector, a line of sight gas detector, and a conical fire detector.

19. A method of optimizing fire and gas detector placement, comprising the steps of:
analyzing a preexisting map of a premises containing at least one fire and gas detector with one or more computer processors based on a plurality of parameters;
identifying an optimum position of at least one fire and gas detector in a premises by use of the one or more computer processors based on the results of the analyzing step; and
generating a 3-dimensional representation of the premises indicating the optimum position of the at least one fire and gas detector.

20. The method of claim 19, wherein the parameters comprise:
a coverage area for the at least one fire and gas detector; and
a 3-dimensional coordinate location of at least one selected from the group of vessels, equipment, buildings, structures and pipelines at the premises.

21. The method of claim 19, wherein in the step of determining the position of at least one fire and gas detector at the premises, the one or more computer processors utilizes a consequence and risk result contour for flammable materials at the premises.

22. The method of claim 19, wherein in the step of determining the position of at least one fire and gas detector at the premises, the one or more computer processors utilizes a consequence and risk result contour for thermal gradients at the premises.

23. The method of claim 19, wherein in the step of determining the position of at least one fire and gas detector at the premises, the one or more computer processors utilizes a consequence and risk result contour for fatalities at the premises.

24. The method of claim 19, wherein the at least one fire and gas detector is one of the group selected from a point gas detector, a line of sight gas detector, and a conical fire detector.
